(19) United States
(12) Patent Application Publication
(10) Pub. No.: US 2015/0373962 A1
(43) Pub. Date: Dec. 31, 2015

(54) LEADER SPIN RIG

(71) Applicant: AWC Distributing, Inc., Minneapolis, MN (US)

(72) Inventor: Kirk Boyer, Lino Lakes, MN (US)

(21) Appl. No.: 14/751,445

(22) Filed: Jun. 26, 2015

Related U.S. Application Data
(60) Provisional application No. 62/017,402, filed on Jun. 26, 2014.

(51) Int. Cl. A01K 91/14; A01K 97/00

(52) U.S. Cl. CPC A01K 91/14; A01K 97/00

(57) ABSTRACT

A leader rig for use in fishing includes a leader line having a distal end and a proximate end with a central line portion located there between. One or more spoons or spinners can be attached to the central line portion. The spoons or spinners are movable along the central line portion and are removable from the central line portion. As such, the leader rig is strong, customizable and capable of use in fishing for a wide variety of target fish.

### CROSS-REFERENCE TO RELATED APPLICATION

This application claims the benefit of U.S. Provisional Patent App. Ser. No. 62/017,402 filed Jun. 26, 2014, the contents of which are hereby incorporated by reference.

### FIELD OF THE INVENTION

The present invention relates generally to the field of fishing, in particular to lead rigs, more particularly to lead rigs having one or more spinner or spoons that are removably attached to a central line portion and capable of rotating independently with respect to the central line portion.

### BACKGROUND OF THE INVENTION

Fishing is the activity of catching fish. Fishing involves specialized equipment such as rods, fishing line, hooks, lures, sinkers, and swivels. Specialized fishing equipment also includes leader rigs. A leader rig is often assembled with different combinations of a main line, leader line, hook, bait or lure, sinker/weight and/or swivel and beads. A leader line is an independent section that ties directly to the main line and is then capable of being attached to the hook or lure. A leader rig may be distinct from the rest of the line and capable of replacement or exchange. The leader line also often allows the hook or lure to be easily exchanged without having to tie a different hook or lure to the main line when a change is desired by the angler.

A leader rig may or may not have a leader line composed of the same type of material, or be of the same weight or density as that of the main line. The type of leader rig chosen depends largely upon the type of fishing and the target fish. When fly fishing, the leader line may be thin to disguise the thickness of the main line. When fishing for target fish that have sharp teeth, a steel leader line or a window-sash chain leader line may be used to prevent the target fish from biting through the line. In addition, a leader line may be comprised of the same material as the main line where the purpose is not visibility or strength, but the ability to customize the length of the leader rig.

Accordingly there is a need in the industry for a leader rig that is strong, customizable and capable of use in fishing for a wide variety of target fish.

### SUMMARY OF THE INVENTION

The present invention relates generally to leader rigs for fishing, the leader rig having one or more spoons or spinners.

In some aspects, a leader rig comprises a leader line having a central line portion and a proximate end capable of attaching to a hook, bait or lure, and a distal end capable of attaching to the main line of a fishing pole. In some aspects, the distal and/or proximate ends have a snap, swivel and/or eyelet for attachment to the respective main line and/or hook, bait or lure.

In some aspects, the leader line has one or more spoons or spinners attached proximate the central line portion. In some aspects, the one or more spoons or spinners are removable from the leader line. The one or more spoons or spinners may comprise various shapes, sizes, textures, colors and materials.

In some aspects, the one or more spoons or spinners are each attached to the central line portion by a clasp. In some aspects, the one or more clasps are removable from the leader line.

In some aspects, the clasp allows the one or more spoons or spinners to rotate independently with respect to the leader line.

In some aspects, the clasp is U-shaped with an aperture at each end that operably engages the leader line by allowing the leader line to be inserted through the aperture, with the spoon or spinner being operably attached to the clasp such that at least a portion of the spoon or spinner is located between the clasp and the leader line, allowing movement of the spoon or spinner with respect to the clasp and leader line.

In some aspects, one or more balls or beads are attached to the leader line proximate the end of the clasp, the one or more balls or beads having an aperture such that the leader line traverses the balls or beads.

In some aspects, one or more spacers are attached to the leader line proximate the end of the clasp or the one or more balls or beads, the one or more spacers having an aperture such that the leader line traverses the spacers. In some aspects, the spacers are crimped, which prevents the respective spoon or spinner, clasp and balls or beads from moving with respect to their position on the leader line. In some aspects, the spacers are partially crimped, which allows the respective spoon or spinner, clasp and balls or beads to be moved with respect to the leader line, but the partial crimping provides resistance from movement during normal operation.

In some aspects, one end of the clasp does not contain a spacer, such that the respective spoon or spinner is capable of traversing the longitudinal length of the leader line until it engages a spacer of another spoon or spinner.

In some aspects, there is at least one spacer located between each of the spoons or spinners. In some aspects, there are at least two spacers located between each of the spoons or spinners.

In some aspects, there is at least one ball or bead located proximate each spoon or spinner.

In some aspects, the leader rig further includes one or more sinkers attached to the leader line. In some aspects, the one or more sinkers are located proximate the distal end of the leader line.

In some aspects, the leader line is comprised of titanium. In some other aspects, the leader line is comprised of stainless steel. In some other aspects, the leader line is comprised of wire, including fluorocarbon and/or monofilament lines.

In some aspects, the leader rig is about 6 inches to about 18 inches in length.

### BRIEF DESCRIPTION OF THE DRAWINGS

FIG. 1A is an image of a leader spin rig according to an embodiment of the present invention.

FIG. 1B is an image of a leader spin rig according to another embodiment of the present invention.

While embodiments are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

Referring now generally to the Figures, the depicted leader spin rig 10 has a central line portion 20 located between a proximate end 30 and a distal end 40.

The proximate end 30 may comprise a proximate means 32 for connecting the central line portion 20 to a main line (not shown) of a fishing pole. In some aspects, the proximate means 32 comprises a snap, a ball-bearing barrel swivel, a swivel and/or eyelet. In some aspects, the proximate means 32 comprises one or more of a snap, a ball-bearing barrel swivel, a swivel and/or eyelet for attachment to the main line. In some aspects, the proximate means 32 comprises a swivel on the proximate end 30 that is capable of being connected to the main line.

The distal end 40 may comprise a distal means 42 for connecting to a hook, bait or lure. In some aspects, the distal means 42 comprises a snap, a ball-bearing barrel swivel, a swivel and/or eyelet. In some aspects, the distal means 42 comprises an eyelet connected to a snap, such that the snap is located on the distal end 40 that is capable of connecting to the hook, bait or lure.

In some aspects during normal use, the proximate means 32 may connect to a main line while the distal means 42 connects to a hook, bait or lure. One of ordinary skill in the art will appreciate that the swivels or ball-bearing barrel swivel allows the main line to articulate independently when attached to the leader spin rig 10.

In some aspects, the proximate end 30 and/or the distal end 40 may comprise a weight (not pictured), such as one or more sinkers.

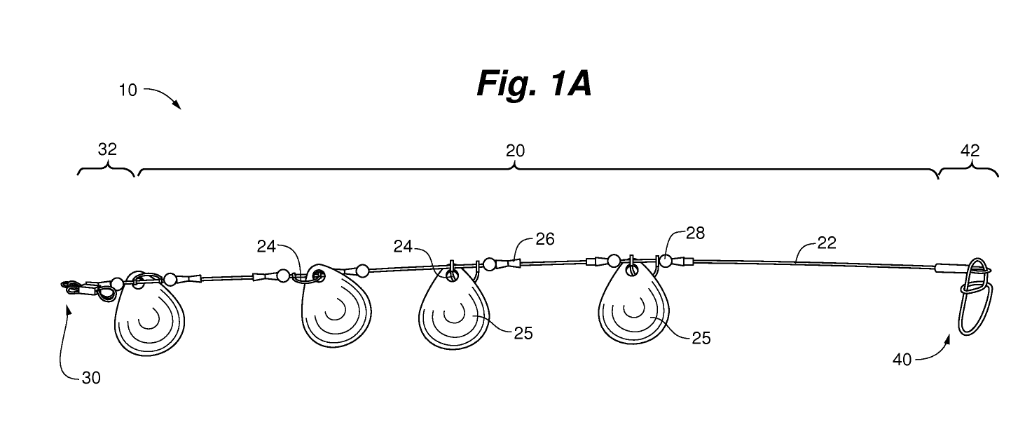

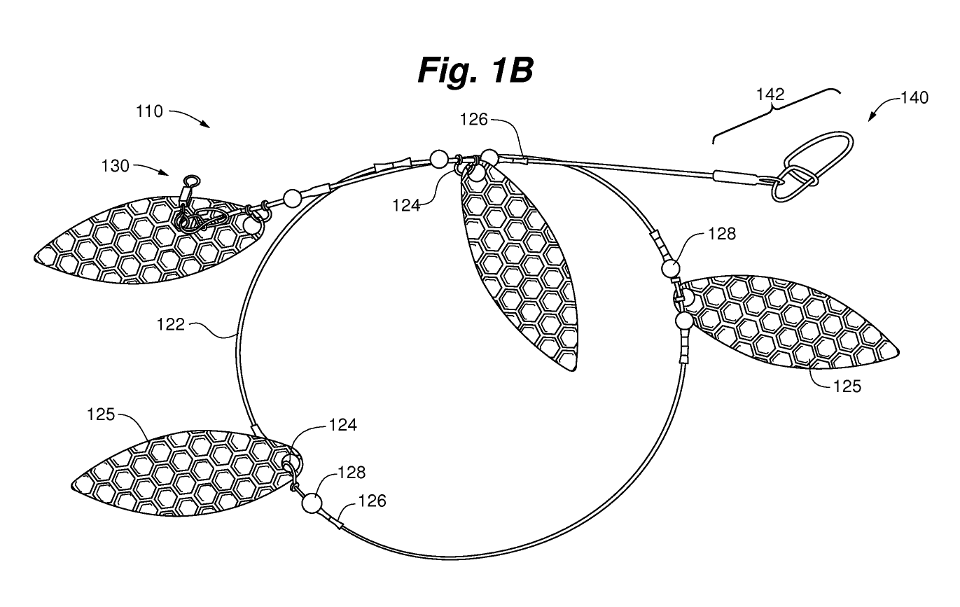

The central line portion 20 comprises a central line 22 and one or more spoons or spinners 25 operably connected to the central line 22 by a fastener such as a clasp 24. In some aspects, the spin rig comprises a plurality of spoons or spinners 25 operably connected to the central line 22 by a fastener such as a clasp 24. In some aspects, the spoon or spinner 25 can be operably connected directly to the central line 22. In some aspects, as shown in FIG. 1A, the clasp 24 is U-shaped with an aperture in each end such that the central line 22 traverses the apertures of the U-shaped clasp 24 providing a hooking region defined by the U-shaped clasp 24 and the central line 22, such that the spoon or spinner 25 can be operably connected to the central line portion 20 by the U-shaped clasp 24 traversing an eyelet or aperture of the spoon or spinner 25 and the central line 22 preventing the spoon or spinner 25 from leaving the portion of the central line 22 proximate the U-shaped clasp 24. In some aspects, the central line portion 20 contains two or more spoons or spinners 25, each operably coupled by a clasp 24 and the central line 22 to the central line portion 20. In some aspects, the central line portion 20 contains a plurality of spoons or spinners 25, each operably coupled by a clasp 24 and the central line 22 to the central line portion 20.

In some aspects, the central line portion 20 also has one or more spacers 26 and/or one or more balls or beads 28 operably coupled to the central line 22. The spacer 26 can have an aperture through which the central line 22 traverses. The spacer 26 can be crimped to the central line 22, such that any component on either side of the spacer 26 cannot move past the spacer 26. In some aspects, the spacer 26 is partially crimped preventing free movement along the axis of the central line 22, such that the spacer 26 can be moved along the axis of the central line 22 by a user with resistance to a desired location on the central line 22, which helps prevent components on either side of the spacer 26 from moving during normal operation. The partial crimping of the spacer 26 allows the user to provide a desired distance between adjacent spoons or spinners 25 and/or provide a longitudinal distance in which the spoon or spinner 25 can move on the central line 22 by virtue of the clasp 24. In some aspects, the clasp 24 allows the spoon or spinner 25 to articulate independently on the central line 22.

In some aspects, a ball or bead 28 is located on each side of the clasp 24. In some aspects, a ball or bead 28 is located on only one side of the clasp 24.

In some aspects, a spacer 26 is located on each side of the clasp 24. In some aspects, a spacer 26 is located on only one side of the clasp 24.

In some aspects, a bead or ball 28 is located between one end of the clasp 24 and a spacer 26. In some other aspects, the leader spin rig 10 has a ball or bead 28 and a spacer 26 located on each end of the clasp 24, such that when the leader spin rig 10 has more than one spoon or spinner 25, such that there are at least two spacers 26 located between each spoon or spinner 25.

In the instances of more than one spoon or spinner 25, each spacer 26 can be adjusted such that the desired distance between each spoon or spinner 25 on the central line 22 can be achieved. In some aspects, the spacer 26 can also be adjusted such that spoon or spinner 25 can traverse a certain longitudinal distance on the central line 22.

In some aspects, the clasp 24, spoon or spinner 25, spacer 26 and/or ball or beads 28 are composed of a metal material, such as titanium, aluminum, tin, stainless steel, or any malleable metal or alloy. In some other aspects, these components are of a plastic or rubber, or any malleable synthetic material.

In some aspects, the one or more spoon or spinners 25 can comprise various shapes, sizes or textures. In some aspects, the ball or bead 28 is spherical. In some other aspects, the ball or bead 28 is polygonal or other geometrically shaped.

In some aspects, the central line 22 is formed from a metal material, such as titanium, stainless steel, aluminum, tin, or any metal or alloy capable of being formed into a line. In some other aspects, the central line 22 is formed from a material chosen from the group consisting of monofilament, fluorocarbon, plastic, rubber, or any synthetic material capable of being formed into a line.

FIG. 1B depicts another embodiment of a leader spin rig 110. In general, like parts are indicated with like numbering. That is, those parts of leader spin rig 110 having similar functions to those of leader spin rig 10 of FIG. 1A are iterated by 100. A central line 120 extends between a proximal end 130 and a distal end 140, and the clasps 124 attach the spoons or spinners 125 to central line 120. The spacers 126 and spheres 128 can be arranged as desired to position spoons/spinners 125 along central line 120.

In the embodiment shown in FIG. 1B, spoons/spinners 125 are differently shaped from the spoons/spinners 25 (FIG. 1A), in that they include a honeycomb pattern of raised bumps. Different sized and shaped spoons/spinners (like 25 or 125) can be used based on the type of fish that is sought. The removability of clasps 124 allows leader spin rigs (10 or 110) to be used in a variety of fishing settings, as these spoons/spinners 125 can be changed out for others, removed, or respaced along central line 120 as often as required.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

We claim:

1. A leader rig for use in fishing, the leader rig comprising:
a leader line having a distal end and a proximate end, with a central line portion located there between; and
one or more spoons or spinners operably attached to the central line portion, wherein the spoons or spinners are movable along the central line portion and are removable from the central line portion.

2. The leader rig of claim 1, has and further comprising two or more spoons or spinners operably attached to the central line portion.

3. The leader rig of claim 1, wherein:
the proximate end is configured to attach to a hook, bait or lure; and
the distal end is configured to attach to a main line.

4. The leader rig of claim 3, wherein the distal and/or proximate ends each include one or more of the group consisting of a snap, swivel and eyelet for attachment to the respective main line and/or hook, bait or lure.

5. The leader rig of claim 1, wherein the one or more spoons or spinners comprises various shapes, sizes, textures, colors and/or materials.

6. The leader rig of claim 1, wherein the one or more spoons or spinners are each attached to the central line portion by a clasp.

7. The leader rig of claim 6, wherein each of the clasps allows the spoon or spinner attached thereto to rotate independently with respect to the leader line.

8. The leader rig of claim 6, wherein the clasp is U-shaped.

9. The leader rig of claim 6, wherein each clasp has an aperture at each end that operably engages the leader line by allowing the leader line to be inserted through the aperture.

10. The leader rig of claim 6, wherein the spoon or spinner is operably attached to the leader line by the clasp such that at least a portion of the spoon or spinner is located between the clasp and the leader line, allowing movement of the spoon or spinner with respect to the clasp and leader line.

11. The leader rig of claim 1, further comprising one or more balls or beads attached to the leader line.

12. The leader rig of claim 15, wherein at least one of the one or more balls or beads is located proximate at least one end of a clasp.

13. The leader rig of claim 1, further comprising one or more spacers connected to the leader line.

14. The leader rig of claim 13, wherein at least one of the one or more spacers is connected to the leader line proximate at least one end of a clasp or a ball or bead.

15. The leader rig of claim 14, wherein the one or more spacers are at least partially crimped to the leader line to prevent a spoon, spinner, clasp, ball, or bead attached to the central line from moving along the central line.

16. The leader rig of claim 15, wherein the at least partially crimped spacers allow at least one component to be moved in a longitudinal direction with respect to the leader line, while providing resistance from such components moving in the longitudinal direction during normal use and operation, wherein the at least one component comprises a corresponding spoons or spinners, clasps, and/or balls or beads coupled to the leader line.

17. The leader rig of claim 16, wherein one end of the clasp does not contain a spacer, such that the component is capable of traversing the longitudinal direction until it engages a spacer associated with another component.

18. The leader rig of claim 1, further comprising one or more sinkers attached to the leader line proximate the distal end.

19. The leader rig of claim 1, wherein the leader line is made of a material, wherein the material is one of the group consisting of titanium, stainless steel, or a fluorocarbon.

20. The leader rig of claim 1, wherein the leader rig is about 6 inches to about 18 inches in length.
